(19) United States
(12) Patent Application Publication
(10) Pub. No.: US 2014/0269240 A1
(43) Pub. Date: Sep. 18, 2014

(54) DRIVE CARRIER SUBSTRATE

(71) Applicants: Andrew James Phelan, Magnolia, TX (US); John P. Franz, Houston, TX (US); Michael S. Bunker, Tomball, TX (US)

(72) Inventors: Andrew James Phelan, Magnolia, TX (US); John P. Franz, Houston, TX (US); Michael S. Bunker, Tomball, TX (US)

(73) Assignee: HEWLETT-PACKARD DEVELOPMENT COMPANY, L.P., Houston, TX (US)

(21) Appl. No.: 14/349,687

(22) PCT Filed: Oct. 25, 2011
(86) PCT No.: PCT/US2011/057638

§ 371 Date: Apr. 4, 2014

(51) Int. Cl. F21V 23/00; G11B 33/10; F21V 21/14

(52) U.S. Cl. CPC F21V 23/005; F21V 21/14; G11B 33/10
USPC 369/53.1; 362/418

(57) ABSTRACT

A drive carrier includes a substrate, a computing device located on the substrate, an electrical interface located on the substrate, and a light source located on the substrate and communicatively coupled to the computing device. The computing device is to control illumination of the light source.

### BACKGROUND

Today's storage demands have created a need for systems that can store a massive amount of data. To this end, storage chassis have been developed to accommodate a plurality of drive assemblies. Each of the plurality of drive assemblies typically comprises a drive such as a hard disk drive (HDD) disposed within a drive carrier. The drive carrier is generally a mechanical device that serves to lock and hold the drive in a particular position within the storage chassis, and to protect the drive from electromagnetic energy interference (EMI) which may be caused by neighboring drives.

### BRIEF DESCRIPTION OF THE DRAWINGS

Example embodiments are described in the following detailed description and in reference to the drawings, in which:

FIG. 1 is a block diagram of a drive carrier in accordance with embodiments;

FIG. 2 is a block diagram of a system in accordance with embodiments;

FIG. 3 is a graphical representation of a substrate assembly in accordance with embodiments;

FIG. 4 is a graphical representation illustrating how a substrate assembly may be affixed to a drive carrier in accordance with embodiments;

FIG. 5 is a graphical representation of a bracket in accordance with embodiments; and

FIG. 6 is a block diagram showing a non-transitory, computer-readable medium having computer-executable instructions stored thereon in accordance with embodiments.

### DETAILED DESCRIPTION

Typical drive carriers are mechanical enclosures that surround and protect all or a portion of a hard drive. These mechanical enclosures generally comprise no electrical components and, at best, may include a light pipe to communicate light originating from a light source on the backplane to the drive carrier bezel. The light from the light source usually appears as a small circle on the drive carrier bezel and conveys a minimal amount of information due to the limited number of light source illumination combinations. Accordingly, typical drive carriers are simple mechanical chassis that have limited functionality outside of their mechanical attributes.

Various embodiments described herein provide an advanced drive carrier. In particular, various embodiments integrate a substrate (e.g., a flexible and/or rigid circuit board) with various electrical components located thereon into a drive carrier to provide advanced functionality. The substrate may be coupled to a backplane of a storage chassis via a connector, and may communicate signals from the backplane to a computing device located on the substrate. Based on these signals as well as other signals and/or sensed conditions, the computing device may carry out novel functionality previously unforeseen with respect to drive carriers. For example, the computing device may control a plurality of light sources also residing on the substrate, conduct drive carrier authentication operations, conduct error logging operations, and/or conduct touch sensing operations. Various embodiments, therefore, increase drive carrier functionality for beyond the functionality provided by typical mechanical drive carriers.

In some embodiments, the drive carrier comprises a flexible circuit board, a computing device located on the flexible circuit board, and a light source located on the flexible circuit board and communicatively coupled to the computing device. The computing device is configured to control illumination of the light source. The computing device is further configured to conduct drive authentication operations and/or store error information. The flexible circuit board may extend from the rear of the drive carrier to a bezel of the drive carrier, and may be affixed to the rear of the drive carrier via a bracket, where the bracket is formed of sheet metal and comprises a plurality of bent flanges that secure the flexible circuit board into the bracket. The flexible circuit board may comprise a plurality of pads, where the pads couple to a connector on a backplane. The flexible circuit board may further comprise a communication path interconnecting the computing device and an electrical interface on the rear of the drive carrier, and at least a portion of the flexible circuit board may be attached to a rigid material. This arrangement may enable information to be communicated between a host device (e.g., an array controller, a host bus adapter (HBA), an expander, and/or a server) and the computing device on the drive carrier via the backplane. Such communication may enable authentication operations, error logging, and/or enhanced light source indications to be provided. In some embodiments, the computing device may control illumination of the light source to illuminate an activity indication, a do not remove indication, and/or a locate indication. The drive carrier, therefore, may serve as more than a simple mechanical device to protect or position a hard drive.

In further embodiments, a system may be provided. The system may comprise a backplane and a plurality of drive assemblies coupled to the backplane. Each drive assembly may comprise a drive carrier, and each drive carrier may comprise a substrate, a computing device located on the substrate, and a light source located on the substrate and communicatively coupled to the computing device. Among other things, the computing device may be configured to control illumination of the light source.

In still further embodiments, a drive carrier is provided. The drive carrier may comprise a substrate, a computing device located on the substrate, an electrical interface located on the substrate, and a light source located on the substrate and communicatively coupled to the computing device. Among other functionalities, the computing device may control illumination of the light source.

FIG. 1 is a block diagram of a drive carrier in accordance with embodiments. The drive carrier 100 comprises a substrate 110, a computing device 120 located on the substrate 110, and a light source 130 located on the substrate 110.

The drive carrier 100 may be constructed of plastic, metal, and/or other materials. It may include a front plate or bezel 140, opposing sidewalls 150, and a floor 160. A drive (not shown), such as a hard disk drive (HDD), solid state drive (SSD), or hybrid drive, may be placed within and/or attached to the area formed by the opposing sidewalls 150, the floor 160, and the front plate 140. The HDD may use spinning disks and movable read/write heads. The SSD may use solid state memory to store persistent data, and use microchips to retain data in non-volatile memory chips. The hybrid drive may combine features of the HDD and SSD into one unit containing a large HDD with a smaller SSD cache to improve performance of frequently accessed files. Other types of drives such as flash-based SSDs, enterprise flash drives (EFDs), and the like may also be used with the drive carrier 100.

A substrate 110 may be attached or otherwise integrated into the drive carrier 100. In embodiments, the substrate 110 may comprise flexible and/or rigid material. For example, the substrate may be a flexible circuit board in accordance with embodiments. More particularly, the substrate 110 may be a flexible plastic substrate such as polyimide, polyether ether ketone (PEEK), transparent conductive polyester film, and/or screen printed silver circuits on polyester. The substrate 110 may be made with photolithographic technology or by laminating thin copper strips between two layers of polyethylene terephthalate (PET) and coating with an adhesive. The substrate 110 may include conductors such as copper or aluminum conductors. The substrate 110 may further include contact pads such as gold contact pads. The substrate 110 may be single-sided, double-sided, single-sided dual access (S2), single-layer, and/or multi-layer. The substrate 110 may accommodate surface mounted devices and/or through-hole devices.

In various embodiments, the substrate 110 may comprise rigid and/or flexible portions. For example, the substrate 110 may comprise a combination of a rigid circuit board and a flexible circuit board. Additionally, the substrate 110 may comprise a flexible circuit board wherein a portion is attached to a backer board or a stiffening support carrier. The backer board or stiffening support carrier may be used, for example, in the bezel portion of the drive carrier to provide additional support for light sources placed thereon, or in the rear portion of the drive carrier to enable a solid and reliable connection with a bracket.

In embodiments, the substrate 110 may extend from the rear of the drive carrier 110 to the bezel of the drive carrier 140. Electrical components such as a computing device 120, light source(s) 130, and/or sensor(s) may be located proximate to the bezel of the drive carrier 140. The substrate 110 may communicate signals received via an electrical interface at the rear of the drive carrier 110 to the computing device 120 via traces.

The computing device 120 may be, for example, a microcontroller, a microprocessor, a processor, a CPLD, an ASIC, or another similar computing device. The computing device 120 may be configured, via instructions stored thereon, to conduct various functions. For example, the computing device 120 may control light source 130. Light source 130 may be, for example, a light emitting device (LED), an incandescent light source, a fluorescent light source, a neon light source, and/or any other type of light source. In some embodiments, the light source 110 may comprise a plurality of light sources. The computing device 120 may drive the light source(s) via signals received from a host device (e.g., an array controller, a host bus adapter (HBA), an expander, and/or a server), signals received from the hard drive associated with the drive carrier, and/or based on conditions sensed by internal or external sensors (e.g., a temperature sensor, a vibration sensor, a touch sensor, an airflow sensor, a humidity sensor, etc.). In some embodiments, the computing device 140 may drive the light source(s) to illuminate an air flow area, to illuminate a do not remove drive indication, and/or to illuminate a self-describing animated image. The computing device 120 may be further configured, via instructions stored thereon, to conduct drive carrier authentication operations and/or to store error information.

FIG. 2 is a block diagram of a system in accordance with embodiments. The system comprises a backplane 210 and a plurality of hot-pluggable drive assemblies 220 coupled to the backplane 210. The system may be located within a storage chassis, cage, disk enclosure, disk array, and/or server, for example. Each drive assembly may comprise a drive carrier 100 and a drive 230 disposed therein. The drive 230 may be, for example, a HDD, a SSD, or a hybrid drive. The drive carrier 100 may be consistent with the drive carrier described above with respect to FIG. 1, and may comprise a substrate 110, a computing device 120, and a light source 130.

A host device 120 (e.g., an array controller, a host bus adapter (HBA), an expander, and/or a server) may communicate with the drive carrier assembly 220 via a first communication channel and a second communication channel. More specifically, the host device 120 may communicate with the drive 230 of the drive assembly 220 via a first communication channel, and may communicate with the computing device 120 of the drive carrier 100 via the second communication channel. The first communication channel and a second communication channel may be isolated communication paths. For example, in embodiments, the first communication channel may not be used to communicate with the computing device 120, and the second communication channel may not be used to communicate with the hard drive 230. The first communication channel may be used for, among other things, communicating read/write commands between a host device and the hard drive 230. By contrast, in embodiments, the second communication channel may not be used to communicate read/write commands from the host device to the hard drive 230. The first communication channel may be, for example, a serial attached SCSI (SAS), a serial advanced technology attachment (SATA), or a fibre communication channel/bus interconnecting a host device and the hard drive 230. The second communication channel may use similar technologies, but may also use an inter-integrated circuit (I2C) communication bus to communicatively couple a host device and/or the backplane 210 with the computing device 120.

FIG. 3 is a graphical representation of a substrate assembly 310 in accordance with embodiments. In particular, FIG. 3 depicts a substrate 320 with a computing device 120, a plurality of light sources 130, and a plurality of contact pads 330 located thereon. The substrate 320 may be formed of flexible material (e.g., flexible circuit board), rigid material (e.g., rigid circuit board), or a combination of both materials. The substrate 320 may extend from the rear of the drive carrier 100 to the bezel 140 of the drive carrier. The portion of the substrate assembly with the computing device 120 and light sources 130 may be located proximate to the bezel of the drive carrier in accordance with embodiments. As discussed in greater detail below, the substrate assembly 310 may be affixed to the rear of the drive carrier via a bracket, where the bracket is formed of sheet metal and comprises a plurality of bent flanges that secure the substrate 110 into the bracket.

A plurality of contact pads 330 on the substrate 110 may couple to a connector on the backplane, and therefore enable signaling between the computing device 120 and the backplane and/or host device. In particular, the plurality of contact pads 330 may be surface mount contact pads which couple to a compression connector attached to the backplane. In embodiments, the plurality of contact pads may be situated in two rows in a staggered configuration, where the pads of one row are aligned between the pads of the other row. The plurality of contact pads 330 may connect to a plurality of traces to communicate a plurality of signals bi-directionally between the pads 330 and the computing device 120. Such signals may include, for example, signals to set the drive carrier address and bay number, signals to indicate hard drive activity, signals to provide power and ground, signals to provide data, signals to set a drive carrier box number and alert a host of a status change, and/or signals for clocking.

FIG. 4 is a graphical representation of how the substrate assembly 310 of FIG. 3 may be affixed to the drive carrier 100 in accordance with embodiments. As shown, the substrate assembly 310 may be coupled to the rear of the drive carrier 410, one of the opposing sidewalls 420, and the front of the drive carrier 430. The substrate may be formed of flexible material, rigid material, or a combination of both. For example, the portion of the substrate at the rear of the drive carrier 410 and the front of the drive carrier 430 may be rigid, and the portion on the sidewall 420 may be flexible. In some embodiments, the substrate may be a flexible circuit board and a stiffening support or backer board may be located behind portions of the flexible substrate to provide support. This arrangement may be used, for example, in the rear portion 410 and front portion 430 of the drive carrier. In some embodiments, the substrate may comprise a combination of rigid circuit board and flexible circuit board in a single continuous piece. In other embodiments, one or more substrates may be communicatively coupled via cabling to one another.

As discussed in further detail below, the substrate assembly 310 may be inserted into a bracket located at a rear portion of the drive carrier 410. This bracket may hold the substrate assembly 310 in place and enable an electrical connection to be made between the plurality of contact pads 330 and a connector located on the backplane. Via this connection, electrical signals may be passed from, e.g., a host device to the computing device 120 by the above-referenced second communication channel (i.e., a communication channel distinct from the first communication channel used to transmit read/write signals between the host device and the hard drive 230). In embodiments, this second communication channel may be an I2C communication bus, and the first communication channel may be a SAS/SATA communication bus.

The substrate assembly 310 may connect to one of the opposing sidewalls 420 via a number of methods. In some embodiments, the substrate assembly 310 may be attached to the opposing sidewall 420 with adhesive or an attachment device (e.g., a screw, clamp, etc.). In other embodiments, the substrate assembly 310 may be attached to the opposing sidewall 420 by placing the substrate assembly 310 within or between portions of the drive carrier sheet metal. In still further embodiments, the substrate assembly 310 may be attached to the opposing sidewall 420 by placing the substrate assembly 310 within a groove of the opposing sidewall 420 designed to accommodate the substrate assembly 310. Similar concepts may be used to attach the substrate assembly 310 to the front and/or rear of the drive carrier. In embodiments, the substrate assembly 310 may be positioned such that a plurality of light sources on the substrate assembly 310 are aligned with indications/buttons/panels on the front of the drive carrier. For example, one or more light sources on the substrate assembly 310 may be located under an eject button to illuminate a “do not remove” indication based on instructions from the computing device 120. In addition, one or more light sources on the substrate assembly 310 may be located under an “activity” indication to illuminate a self-describing animated activity indication. Furthermore, one or more light sources may be positioned under an airflow area or air vent to illuminate a large area for, e.g., hard drive locate functionality.

FIG. 5 is a graphical representation of a bracket in accordance with embodiments. The bracket 500 may be constructed of sheet metal to secure the substrate 110 in a particular position. The substrate 110 may be secured and aligned within the bracket 500 to provide a proper electrical connection with a connector on the backplane 210. In particular, the bracket 500 and substrate may be aligned such that the contact pads 530 make contact with a connector on the backplane, and thereby a proper connection is achieved between the backplane and the computing device 120 via the pads 530 and trace routing 540.

In embodiments, the bracket 500 may secure the substrate 110 in place without the use of adhesive or an attachment device (e.g., a screw, clip, etc.). In particular, the bracket 500 may use a combination of 90° flanges 510 and/or bent/angled flanges 520 to enable the substrate to be inserted and held in a position that does not allow for movement or dislodging during normal operation. This arrangement may reduce expense by not incorporating adhesive. Furthermore, this arrangement may eliminate curing/pressure concerns with regard to time/temperature/humidity breakdown of the adhesive. Of course, adhesive and/or further attachment components may be used in accordance with further embodiments if desired.

FIG. 6 is a block diagram showing a non-transitory, computer-readable medium having computer-executable instructions stored thereon in accordance with embodiments. The non-transitory, computer-readable medium is generally referred to by the reference number 610 and may be included in computing device 120 of drive carrier 100 described in relation to FIG. 1. The non-transitory computer-readable medium 610 may correspond to any typical storage device that stores computer-implemented instructions, such as programming code or the like. For example, the non-transitory computer-readable medium 610 may include one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. A processing core 620 generally retrieves and executes the instructions stored in the non-transitory, computer-readable medium 610 to operate the computing device 120 in accordance with embodiments.

In some embodiments, the instructions, upon execution, may cause the computing device 120 to control a light source 130 to illuminate an air flow area, illuminate a drive not remove indication, and/or illuminate a self-describing animated image. For example, the computing device 120 may control the light source 130 to substantially illuminate an air flow and/or air vent area. This illumination may be used in conjunction with a drive locate feature to illuminate a large area and make it easier to identify a drive assembly within a chassis full of drives assemblies, and thereby ease the burden on on-site technicians trying to locate a drive among a sea of similar drives. The computing device 120 may additionally control the light source 130 to, for example, produce a self-describing animated image. This may be accomplished by turning on and off the plurality of light sources 130 in a predetermined or predeterminable sequence. In one example, the multiple light sources 130 may be arranged in a circle or ring configuration. The computing device 120 may turn on/off the light sources 130 to produce an animated image of a spinning disk or hard drive activity. Moreover, the computing device 120 may turn on/off the light at a particular rate to give the appearance of varied intensity/brightness. This animated image of a spinning disk may be activated when, for example, the computing device 120 determines that an associated HDD has an outstanding command. The computing device 120 may further control the light source 130 to, for example, illuminate a do not remove indication. The do not remove indication may be part of an eject button and may be created via an in-mold decorating process. More specifically, in an example, the computing device 120 may control a light source 130 inside a hard drive carrier eject button such that an icon is illuminated to inform a viewer that ejecting the drive will result in a logical drive failure. A user, therefore, has instant knowledge and confidence that a drive is safe to remove. As a result, self-inflicted logical drive failures may be reduced. Moreover, removal of a drive against an administrator's wishes or in violation of another rule may be reduced.

In further embodiments, the instructions, upon execution, may cause the computing device 120 to receive measurements from internal sensors or external sensors located on the substrate 110. In some embodiments, a sensor may be a touch sensor and the computing device 120 may determine based on a sensor measurement if the sensor has been touched. In response to a determination that the sensor has been touched, the computing device 120 may conduct a process such as outputting from the computing device a signal indicating that the sensor has been touched, issuing a command to create a default logical drive, changing or toggling device definitions, and/or providing an early drive removal indication to another device. In further embodiments, the sensor may be a temperature sensor, a vibration sensor, a touch sensor, an airflow sensor, and/or a humidity sensor. The computing device 120 may receive measurements from the sensor and provide/store environmental data based on the measurements. The environmental data may comprise information such as a measured temperature, a measured airflow amount, a measured vibration, and/or a measured humidity.

In still further embodiments, the instructions, upon execution, may cause the computing device 120 to store error information. In particular, the computing device may receive data from a host device and store the data on an internal or external memory to enable manufacturers to identify and understand the cause of failure indications. The data may include, for example, a reason for the failure determination (e.g., a failure code), a reason for the predictive failure determination (e.g., a predictive failure code), a time, and/or a date.

In additional embodiments, the instructions, upon execution, may cause the computing device 120 to conduct authentication operations. For example, computing device resident on the drive carrier may be configured to receive a challenge value and a first value from a host device, determine a second value based on at least the first value, and generate a response value based on the challenge value and the second value. This response value may be used by a host device to determine if the drive carrier is authentic, and therefore may help reduce the confusion, down time, brand name harm, and lost revenue created by black market drive carriers.

What is claimed is:

1. A drive carrier, comprising:
a flexible circuit board;
a computing device located on the flexible circuit board; and
a light source located on the flexible circuit board and communicatively coupled to the computing device,
wherein the computing device is to control illumination of the light source.

2. The drive carrier of claim 1, wherein the flexible circuit board extends from the rear of the drive carrier to a bezel of the drive carrier.

3. The drive carrier of claim 1, wherein the flexible circuit board is affixed to the rear of the drive carrier via a bracket.

4. The drive carrier of claim 3, wherein the bracket is formed of sheet metal and comprises a plurality of bent flanges that secure the flexible circuit board into the bracket.

5. The drive carrier of claim 1, wherein the flexible circuit board further comprises a plurality of pads, and wherein the plurality of pads are to couple with a connector on a backplane.

6. The drive carrier of claim 1, wherein the flexible circuit board further comprises a communication path interconnecting the computing device and an electrical interface on the rear of the drive carrier.

7. The drive carrier of claim 1, wherein at least a portion of the flexible circuit board is attached to a rigid material.

8. The drive carrier of claim 1, wherein the computing device is to conduct drive carrier authentication operations.

9. The drive carrier of claim 1, wherein the computing device is to store error information.

10. The drive carrier of claim 1, wherein the computing device is to control illumination of the light source to illuminate an activity indication, a do not remove indication, or a locate indication.

11. A drive carrier, comprising:
a substrate;
a computing device located on the substrate;
an electrical interface located on the substrate; and
a light source located on the substrate and communicatively coupled to the computing device,
wherein the computing device is to control illumination of the light source.

12. The drive carrier of claim 11, wherein the substrate comprises a flexible circuit board.

13. The drive carrier of claim 11, wherein the substrate comprises flexible and rigid material.

14. A system, comprising:
a backplane; and
a plurality of drive assemblies coupled to the backplane, wherein each drive assembly comprises a drive carrier, and wherein each drive carrier comprises
a substrate;
a computing device located on the substrate; and
a light source located on the substrate and communicatively coupled to the computing device,
wherein the computing device is to control illumination of the light source.

15. The system of claim 14, wherein the substrate comprises flexible and rigid material.
